(19) United States
(12) Patent Application Publication
(10) Pub. No.: US 2026/0120568 A1
(43) Pub. Date: Apr. 30, 2026

(54) SYSTEMS AND METHODS FOR TRANSMITTING ROADWAY INFORMATION

(71) Applicant: William James Smurthwaite, JR., Landenberg, PA (US)

(72) Inventor: William James Smurthwaite, JR., Landenberg, PA (US)

(21) Appl. No.: 18/925,573

(22) Filed: Oct. 24, 2024

(51) Int. Cl. G08G 1/09; H04W 4/06; H04W 4/44

(52) U.S. Cl. CPC G08G 1/091; H04W 4/06; H04W 4/44

(57) ABSTRACT

A roadway information dispersal system is disclosed, including at least one user computing device in operable connection with a user network. An application server is in operable communication with the user network to host an application program for enabling the input, via an input module, of a plurality of roadway information. A communication module transmits the plurality of roadway information to a CPU. One or more FM transmitters emit a signal to a vehicle's radio to enable the reception of the plurality of roadway information.

### TECHNICAL FIELD

The embodiments disclosed herein generally relate to systems and methods for transmitting roadway information to motorists.

### BACKGROUND

It is important for vehicle operators and travelers to be aware of changing roadway conditions, such as changes caused by nearby construction, inclement weather, traffic, and other causative factors in order to promote safety through relevant alerts. Commonly, state agencies and construction crews (or other entities, groups, or individuals) employ signage which is visible to motorists which inform them of impending changes to roadway conditions and hazards. While standardized signs have been common throughout history, these signs cannot be dynamically changed based on specific factors which may affect the safety and of the roadway.

More recently, the use of dot-matrix displays has become increasingly common. These displays allow for the information displayed thereon to be changed based on specific conditions, hazards, effected time periods, and the like. Dot-matrix displays are limited to two “pages” of information and may only allow for 8-10 words to be displayed in most cases. These displays also require motorists to divert their attention away from the roadway.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a roadway information dispersal system, including at least one user computing device in operable connection with a user network. An application server is in operable communication with the user network to host an application program for enabling the input, via an input module, of a plurality of roadway information. A communication module transmits the plurality of roadway information to a CPU. One or more FM transmitters emit a signal to a vehicle's radio to enable the reception of the plurality of roadway information.

The embodiments provide a means for transmitting up-to-date information in real-time to motorist travelling through an event region, such as a construction zone, region experiencing weather-induced traffic delays, roadway hazards, increased traffic delays, and the like. The system may be updated via users in real-time to provide an efficient means of transmitting relevant roadway information in a less expensive manner than traditional means (e.g., dot-matrix signs) commonly used in the industry. Information will be made available to the user for an extended period of time, such that the motorist does not need to divert their attention from the roadway. The system also enables the transmission of a message having larger amounts of content when compared to typical dot-matrix signs.

In one aspect, the system includes a power source which may be in electric communication with at least one solar cell.

In one aspect, the sign is a digital sign to receive the plurality of roadway information in real-time from the at least one user computing device. Alternatively, the sign may be a static sign which displays a fixed notification such that it is visible to the motorist.

In one aspect, the application program includes a database to store a plurality of prerecorded messages.

In one aspect, the input module enables the selection of at least one of the plurality of prerecorded messages. The at least one selected prerecorded message is transmitted to the roadway information dispersal system.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program in communication with the computer system, according to some embodiments;

FIG. 3 illustrates a block diagram of the roadway information dispersal system, according to some embodiments;

FIG. 4 illustrates a schematic of the system's implementation along a roadway, according to some embodiments; and

FIG. 5 illustrates a flowchart of a process for implementing a roadway information dispersal system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to systems and methods for transmitting information to motorists as a means of increasing roadway safety. The embodiments provide an efficient system for transmitting roadway information such as safety information, weather information, hazard information, construction information, and other information which may affect roadway conditions, travel efficiency, and safety. The system is capable of receiving customized information, which is input by an administrator, construction project manager, weather service, Department of Transportation personnel, and the like which is deemed useful or otherwise pertinent to motorists traveling on the roadway.

As used herein, the terms “motorist” or “motorists” is used to describe vehicle operators, passengers, or other travelers utilizing a roadway.

As used herein, the term roadway information may relate to any information which effects roadway conditions, safety, travel time, hazards, weather information, and the like. For example, roadway information may be transmitted which alerts motorists of upcoming construction which may affect travel along the roadway. In another example, the roadway information may include estimated delays or travel time estimates to a particular location, or through a particular section of the roadway. Roadway information may also be used to communicate an estimated time period associated with a construction project (e.g., construction between 9 PM and 5 AM between January 1^{st} and February 1^{st}).

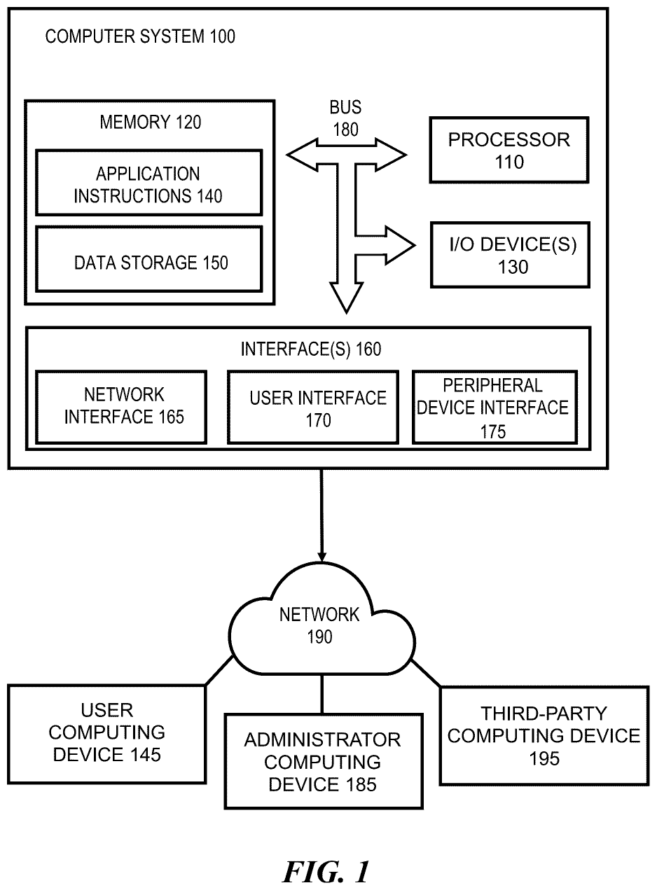

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

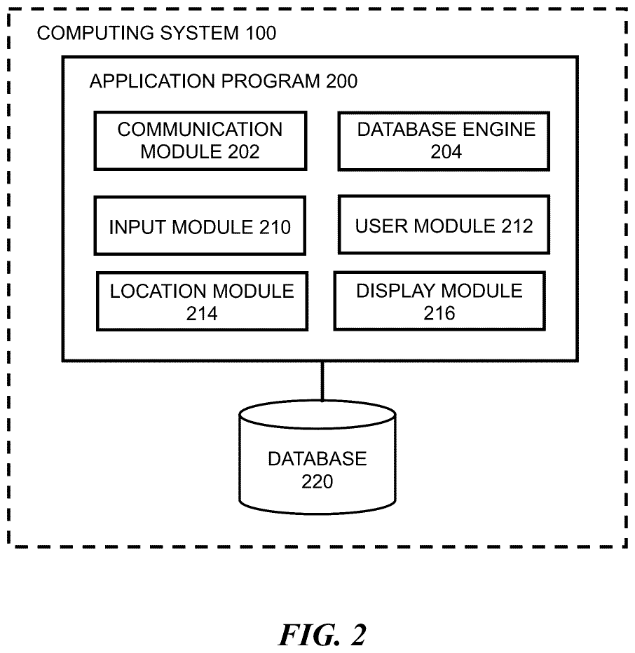

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases 220. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, an input module 210, a user module 212, a location module 214, and a display module 216.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the user computing device 145, the administrative computing device 185, and/or one or more third-party computing device(s) 195.

In some embodiments, the communication module 202 may be used to communicate transmit communication information (e.g., an FM radio channel, AM radio channel, or similar public-access channel) to a sign having a display. In such, the user can assign or otherwise associate a communication channel with a communication they transmit using the channel. The communication may include an alert to notify a motorist of roadway conditions (i.e., construction zone notifications and information, weather information, travel information, traffic information, etc.).

In some embodiments, the communication module 202 may be used to record an audible message associated with the roadway information. The communication module 202 may then transmit the audible message to an FM (or similar) transmitter operable to broadcast the message via the radio of the vehicle.

In some embodiments, the communication module 202 may be capable of transmitting the message to the alert system of a vehicle. In such, the vehicle's alert system receives the message and displays, emits an audible sound, or otherwise alerts the driver of the message and associated roadway information.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the database engine 204 may be operable to transmit and receive information to and from a database 200. The database 200 may be utilized to store prerecorded messages which can be broadcast to the vehicle's radio, or a smart device (i.e., a smartphone).

In some embodiments, the input module 210 is operable to receive a user input, via the I/O devices associated with the user computing device. The input module 210 may enable users to input, such as via voice or text) customized messages which are transmitted via the communication module 202. In such, the input module 210 may enable the user to preemptively input various messages which can be transmitted dependent on real-time roadway conditions.

In some embodiments, the user module 212 facilitates the creation of user account which may be used to associate the user with an entity (i.e., a construction company). Once the user account has been created, the user's identity, entity identity, etc. may be verified to ensure the user is able to input and broadcast the roadway information.

In some embodiments, a location module 214 enables the determination of the location of a particular roadway sign, location of roadway conditions, user location(s), vehicle location(s), etc. which can be used to accurately disseminate relevant roadway information. For example, the user may indicate that a recorded message is to be associated with a sign located at a specific mile marker on the highway. The location module 214 ensures that the communication module 202 transmits the signal to the FM transmitter(s) associated with the sign. This ensures the motorist receive an accurate message alerting them of upcoming roadway conditions.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

The display module 216 may be operable to enable the user to select a location, select a particular sign, select an FM transmission protocol, select from a plurality of prerecorded messages, and/or enable the input of a new message.

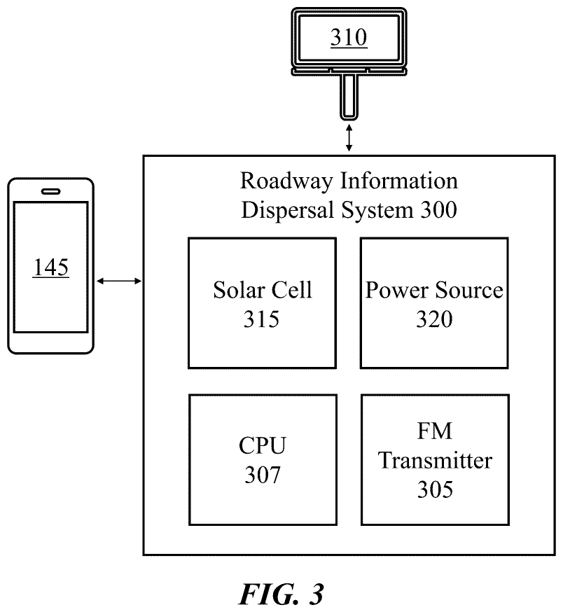

FIG. 3 illustrates a block diagram of the roadway information dispersal system 300. A user device 145 such as a smartphone, computer, tablet, etc. is utilized by a user to access the application program. The user may then select from a plurality of functions provided by the application system including selecting a schedule for a message to be transmitted via the one or more FM transmitter(s) 305. The user may also select a prerecorded message or input a new message using the user computing device 145. Further, the user computing device 145 may be utilized by the user to indicate a location at which the message is to be transmitted via the FM transmitter. In one example, the user may select that construction is occurring at mile marker 100 in Arizona on Interstate 10 between 10 AM and 5 PM. This message may be accompanied by an alert indicating that traffic has slowed, and travel delays are to be expected. A computer processing unit (CPU) 307 is in communication with the FM transmitter 305 and the user computing device 145. As the motorist passes the sign 310, the motorist is instructed to tune the vehicle's radio to a specific FM channel which broadcasts the selected message and other roadway information which has been selected by the user. The CPU 300, FM transmitter 305, and/or the sign 310 may be powered by a power source 320 which may include a solar cell 315 to provide energy to the power source 320. Alternatively, the power source 320 and/or the sign 310 may be hardwired to a power grid, generator, or other power supply.

The roadway information dispersal system 300 components shown in FIG. 3 may be housed in a roadside box or similar structure or may be incorporated into the sign 300. In such, the electrical components are protected from the elements or tampering.

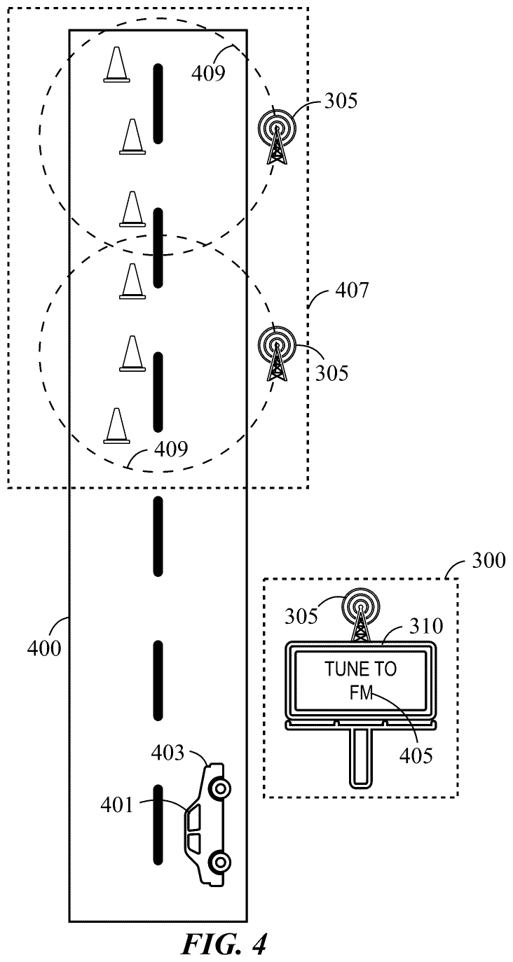

FIG. 4 illustrates a schematic of the roadway information dispersal system's 300 implementation along a roadway 400. The roadway information dispersal system 300 is capable of transmitting a display signal to the sign 310 positioned alongside the roadway 400. In such, motorists 401 operating, or passengers within a vehicle 403 can view the sign 310 which displays a notification 405. In one example, the notification 405 may instruct the motorist 401 to “tune to FM channel 88.0 (the specific FM channel described herein is used by way of example only and can be configured to be any accessible FM channel in a particular location). For example, in the United States the channel may be between 88.0 to 108.0. The sign 310 is positioned ahead of an event region 407 which may be a construction zone, region experiencing weather, an area wherein a hazard exists, an area where traffic has slowed or is otherwise abnormal, etc. The motorist 401 or other individual may then tune the vehicle's 403 radio, their computing device, or other device to the channel displayed on the sign. One or more FM transmitters 305 are positioned such that a signal 409 is broadcast in the particular location which is near the event region 407. This allows the motorist 401 to hear the message including the roadway information that has been selected by the user as described hereinabove. Once the vehicle exits the event region 407, the vehicle is outside of the signal 409 radius and the motorist 401 can no longer hear the message being transmitted.

In some embodiments, the sign 310 may be an electronic display to enable the dynamic display of the notification 405. Alternatively, the sign 310 may not be electronic and may be positioned in front of the travel path of the event region 407. In such, the sign 310 may only display a static notification which is only modifiable by changing the sign 310 itself on-location.

In some embodiments, the FM transmitter(s) 305 may be positioned at intervals along the roadway 400 based on the signal radius which can be emitted by the FM transmitter(s). For example, if the FM transmitters 305 have a signal radius of 200 m and the event region 407 has a length of 800 m, the two FM transmitters are positioned 200 m apart from one another such that the message is transmitted throughout the entirety of the event region 407.

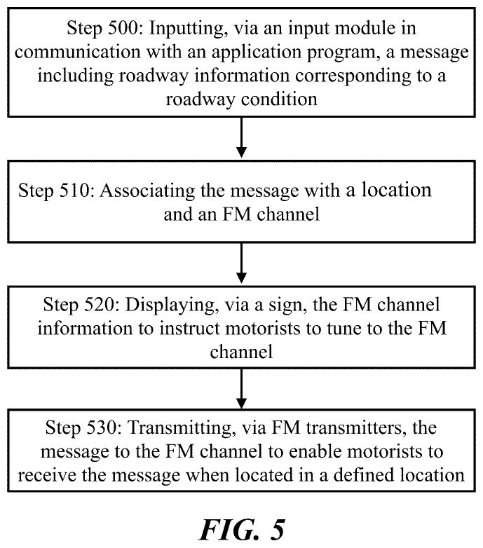

FIG. 5 illustrates a flowchart of a process for implementing a roadway information dispersal system via the transmission of customizable roadway information. In step 500, a message is input, via a user and the input module in communication with the application program. The message includes roadway information which corresponds to at least one roadway condition. In step 510, the message is associated with a location and an FM channel. In step 520, the sign positioned near the selected location then displays the FM channel selected by the user. In step 530, the message is then transmitted by one or more FM transmitters to inform the motorists of the roadway condition.

In some embodiments, the location module enables the input of a location which corresponds to the event region. The selection of the location instructs the roadway information dispersal system to transmit the message using a subset of the one or more FM transmitters which are capable of transmitting the message within the event region.

In this disclosure, the various embodiments are described with reference to the flowchart illustrations and/or block diagrams of methods, apparatus (systems), and computer program products.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A roadway information dispersal system, comprising:
at least one user computing device in operable connection with a user network;
an application server in operable communication with the user network, the application server configured to host an application program for enabling the input, via an input module, of a plurality of roadway information;
a communication module to transmit the plurality of roadway information to a CPU;
one or more FM transmitters to emit a signal to a vehicle's radio to enable the reception of the plurality of roadway information.

2. The system of claim 1, wherein the roadway information dispersal system is further comprised of a power source.

3. The system of claim 2, wherein the power source receives energy from at least one solar cell.

4. The system of claim 1, wherein the sign is a digital sign to receive the plurality of roadway information in real-time from the at least one user computing device.

5. The system of claim 1, wherein the application program includes a database to store a plurality of prerecorded messages.

6. The system of claim 5, wherein the input module enables the selection of at least one of the plurality of prerecorded messages, and wherein the at least one selected prerecorded message is transmitted to the roadway information dispersal system.

7. The system of claim 1, further comprising a location module to enable the selection of the sign based on its location in relation to the event region.

8. A system for enabling the transmission of roadway information to an event region, the system comprising:
at least one user computing device in operable connection with a user network;
an application server in operable communication with the user network, the application server configured to host an application program for enabling the input, via an input module, of a plurality of roadway information;
a communication module to transmit the plurality of roadway information to a CPU;
one or more FM transmitters to emit a signal to a vehicle's radio to enable the reception of the plurality of roadway information, wherein the one or more FM transmitters are positioned within a signal radius, the signal radius to emit the message within an event region, wherein the message corresponds to at least one roadway condition within the event region.

9. The system of claim 8, wherein the roadway condition is associated with at least one of the following: a construction event, a traffic delay, a hazard, and a weather condition.

10. The system of claim 8, wherein the one or more FM transmitters are in operable communication with the user computing device to enable the user computing device to receive the message.

11. The system of claim 8, wherein the one or more FM transmitters are interspaced along a roadway, and wherein the distance between each of the one or more GM transmitters corresponds to the signal radius.

12. The system of claim 8, wherein the event region defines a portion of a roadway wherein the at least one roadway condition is in effect.

13. The system of claim 8, wherein the roadway information dispersal system is further comprised of a power source, and wherein the power source receives, at least in part, energy from at least one solar cell.

14. The system of claim 8, wherein the sign is a digital sign to receive the plurality of roadway information in real-time from the at least one user computing device.

15. The system of claim 8, wherein the application program includes a database to store a plurality of prerecorded messages.

16. The system of claim 15, wherein the input module enables the selection of at least one of the plurality of prerecorded messages, and wherein the at least one selected prerecorded message is transmitted to the roadway information dispersal system.

17. The system of claim 16, further comprising a location module to enable the selection of the sign based on its location in relation to the event region.

18. A method for transmitting customizable roadway information, the method comprising the steps of:
inputting, via an input module in communication with an application program, a message including a plurality of roadway information corresponding to at least one roadway condition;
associating the message with a location and an FM channel;
displaying, via a sign, the FM channel to instruct one or more motorists to tune a vehicle's radio to the FM channel; and
transmitting, via one or more FM transmitters, the message to the FM channel to enable the one or more motorists to receive the message when the one or more motorists are traveling through an event region.

19. The method of claim 18, further comprising the steps of:
storing, via the database, one or more prerecorded messages;
selecting, via a user, at least one of the prerecorded messages; and
transmitting, via the communication module, the selected prerecorded messages to the roadway information dispersal system.

20. The method of claim 19, inputting, via a location module, a location corresponding to the event region, wherein the selection of the location instructs the roadway information dispersal system to transmit the message using a subset of the one or more FM transmitters which are capable of transmitting the message within the event region.
